(19) United States
(12) Patent Application Publication
(10) Pub. No.: US 2016/0188528 A1
(43) Pub. Date: Jun. 30, 2016

(54) ELECTRONIC SYSTEM WITH STORAGE CONTROL MECHANISM AND METHOD OF OPERATION THEREOF

(71) Applicant: Samsung Electronics Co., Ltd., Suwon-si (KR)

(72) Inventors: Siamack Haghighi, Sunnyvale, CA (US); Pradeep Bisht, Sunnyvale, CA (US); Indira Joshi, Saratoga, CA (US); Robert Brennan, Santa Clara, CA (US)

(21) Appl. No.: 14/882,056

(22) Filed: Oct. 13, 2015

Related U.S. Application Data
(60) Provisional application No. 62/099,048, filed on Dec. 31, 2014.

(51) Int. Cl. G06F 15/173; H04L 29/12; H04L 29/08; G06F 3/06

(52) U.S. Cl. CPC G06F 15/17331; G06F 3/0604; G06F 3/0629; G06F 3/067; H04L 61/6004; H04L 67/1097

(57) ABSTRACT

An electronic system includes: a management server providing a management mechanism with an address structure having a unified address space; a communication block, coupled to the management server, configured to implement a communication transaction based on the management mechanism with the address structure having the unified address space; and a server, coupled to the communication block, providing the communication transaction with a storage device based on the management mechanism with the address structure having the unified address space.

### CROSS-REFERENCE TO RELATED APPLICATION(S)

This application claims the benefit of U.S. Provisional Patent Application Ser. No. 62/099,048 filed Dec. 31, 2014, and the subject matter thereof is incorporated herein by reference thereto.

### TECHNICAL FIELD

An embodiment of the present invention relates generally to an electronic system, and more particularly to a system with storage control.

### BACKGROUND

Modern electronics, including devices such as cellular phones, portable computers, graphical display systems, or combination devices, are providing increasing levels of functionality to support modern life. Research and development in the existing technologies can take a myriad of different directions.

The increasing levels of functionality typically require access to information and commensurate memory and storage. Memory and storage capacity and bandwidth can be key factors in increasing device or system performance and functionality. Many electronic devices access information storage on computers that trade off area and cost with cost performance and functionality.

Storage transactions can improve device or system performance and functionality. Unfortunately storage transactions can have performance and functionality limitations such as scalability, latency, cost effectiveness, cost of ownership, bandwidth limits, or combination thereof. Any of all of these limitations reduce system performance and functionality. Embodiments of the invention provide improved storage transactions.

Thus, a need still remains for an electronic system with storage control mechanism to improve system performance. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a management server providing a management mechanism with an address structure having a unified address space; a communication block, coupled to the management server, configured to implement a communication transaction based on the management mechanism with the address structure having the unified address space; and a server, coupled to the communication block, providing the communication transaction with a storage device based on the management mechanism with the address structure having the unified address space.

An embodiment of the present invention provides a method of operation of an electronic system including: providing, with a management server, a management mechanism with an address structure having a unified address space; implementing, with a communication block coupled to the management server, a communication transaction based on the management mechanism with the address structure having the unified address space; and providing, with a server coupled to the communication block, the communication transaction with a storage device based on the management mechanism with the address structure having the unified address space.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an example of a plan view of a portion of an electronic system in an embodiment of the invention.

FIG. 2 is an example of a block diagram of an electronic system in an embodiment of the invention.

FIG. 3 is an example of a plan view of a portion of an electronic system in an embodiment of the invention.

FIG. 4 is an example of a plan view of a portion of an electronic system in an embodiment of the invention.

FIG. 5 is example embodiments of the invention.

FIG. 6 is a flow chart of a method of operation of the electronic system in an embodiment of the present invention.

### DETAILED DESCRIPTION

An electronic system in embodiments of the invention can include a very high performance, low latency storage array using switching fabric technology. Data center applications, hyperscale computing applications, or combination thereof, can benefit from very high performance, low latency storage, particularly with multi-server shared drives, storage area networks (SAN), storage appliances, or combination thereof.

An electronic system in embodiments of the invention can provide high performance scalability with multiple servers, scalability with multiple storage devices, high bandwidth, low latency, cost effectiveness, low total cost of ownership (TCO), or combination thereof. These improvements significantly exceed direct attached storage (DAS), fiber channel solutions, ethernet storage area networks, storage appliances, or combination thereof. For example, the switching fabric technology can provide scalability for multiple servers and multiple storage devices with comparable performance to DAS storage devices.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

For example, the hardware referred to herein can include gates, circuitry, processor, computer, integrated circuit, integrated circuit cores, a pressure sensor, an inertial sensor, a microelectromechanical system (MEMS), passive devices, physical non-transitory memory medium having instructions for performing the software function, a portion therein, or a combination thereof. Further, if a module is written in the apparatus claims section below, the modules are deemed to include hardware circuitry for the purposes and the scope of apparatus claims.

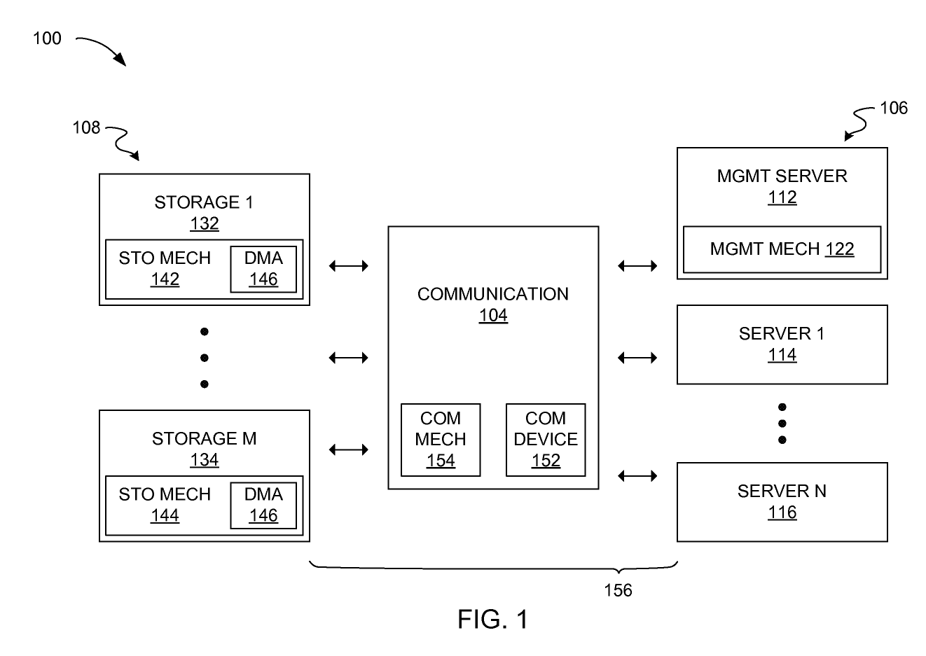

Referring now to FIG. 1, therein is shown an example of a plan view of a portion of an electronic system 100 in an embodiment of the invention. The electronic system 100 with storage control mechanism can provide connection, communication, or combination thereof for storage devices and servers. For example, a communication block 104 can connect servers 106 and storage devices 108.

In an embodiment, the electronic system 100 can include switch fabric, server management, unified address space, or combination thereof, for providing a scalable, multi-server, multi-storage system with very high performance, low latency, and low total cost of ownership (TCO). The electronic system 100 can include low cost interconnect technology such as switch fabric with simplified addressing such as unified addresses for connecting multiple servers 106 with multiple storage devices 108.

In an embodiment, the communication block 104 can include physical interconnect, communication devices, network devices, switch devices, switch fabric devices, or combination thereof. The communication block 104 can include high performance, low latency interconnect fabric for point to point, parallel connectivity for the servers 106 and the storage devices 108. The communication block 104 can provide data exchanges with any of the servers 106 and any number or combination of the storage devices 108.

In an embodiment, the servers 106 can include computer devices, compute servers, storage servers, a rack of servers, a server array, server blades, any servers, or combination thereof. The servers 106 can include a management server 112, a server “One” 114 thorough a server “N” 116, any server, any number of servers, or combination thereof. For example, the servers 106 can include the Nth server 116 with “N” representing a highest numbered of the servers 106. For illustrative purposes, three of the servers 106 are shown although it is understood that any number of the servers 106 may be included. Any number of the servers 106 is depicted with ellipses and the “N” designation.

For example, the management server 112 can enumerate the storage devices 108 including solid state drives (SSD) such as PCIe® SSDs, assign SSD access to any number of the servers 106, or combination thereof. The management server 112 can manage access, assignment, redundancy, fault replacement, failover, or combination thereof, for the servers 106 with any of an array of the storage devices 108. The management server 112, with the communication block 104, can provide very high performance and low latency at a low total cost of ownership.

In an embodiment, the servers 106 including the management server 112 can manage, assign one or more of the storage devices 108 or a portion of a storage device 108 to one or more of the servers 106, provide fault replacement including failover for one or more of the storage devices 108, enumerate one or more of the storage devices 108 such as at power up, or combination thereof.

For example, the servers 106 can directly manage access to the storage devices 108 without the need for a non-transparent (NT) bridging mechanism. Further, the management server 112 can provide the servers 106 with shared access to the storage devices 108 through the communication block 104 including management mechanisms 122. The management mechanisms 122 can include domain isolation bridging technology whereby two or more independent address space domains can be accessible via a bridge through address translation, message passing, or combination thereof. For example non-transparent (NT) bridge, a non-transparent virtual (NTV) bridge, PCIe® NT end point bridge, PCIe® NTV end point bridge, a non-transparent link (NTL) bridge, any address based interconnect technology, any switch fabric technology operating with domain address values, any switch fabric technology operating through messages, or combination thereof.

In an embodiment, the servers 106 including the management server 112 can provide addressing such as unified addressing, flat addressing, a unified flat address space, programmable address translation, or combination thereof. The servers 106 including the management server 112 can provide the addressing to manage, enumerate, configure, assign, or combination thereof, the servers 106 and the storage devices 108 or a portion of a storage device 108 through the communication block 104.

In an embodiment, the management server 112 can assign and directly address resources of the servers 106, the storage devices 108, or combination thereof, including system resources, system memory, individual storage configuration registers, storage drive configuration, system peripherals, system storage devices, any memory, or combination thereof, with a unified address space. For example, a unified address space including a single unified address space, can include sixty-four bit (64-bit) addressing including management of the servers 106, the storage device 108, or combination thereof.

In an embodiment, the servers 106 including the management server 112 can include a programmable address translation mechanism to enable high performance, high wire rate, bidirectional communication, or combination thereof. The bidirectional communication can include communication with the servers 106, the storage devices 108, or combination thereof. For example, the servers 106 can use the management mechanisms 122 including a translated address map of a unified address space to operate or access one or more of the storage devices 108.

In an embodiment, the storage devices 108 can include storage devices, storage drives, solid state storage drives, hard disk drives, non-volatile memories, any electronic storage, or combination thereof. The storage devices 108 can include a first storage device 132, an Mth storage device 134, or combination thereof. For example, the storage devices 108 can include the Nth storage device 134 with “M” representing a highest numbered of the storage devices 108. For example as shown, the Mth storage device 134 can be the second storage device 134 of two storage devices 106. For illustrative purposes, two of the storage devices 108 are shown although it is understood that any number of the storage devices 108 may be included. Any number of the storage devices 108 is depicted with ellipses and the “N” designation.

In an embodiment, the storage devices 108 can include first storage mechanisms 142, Mth storage mechanisms 144, any storage mechanism, any number of storage mechanisms, or combination thereof. The first storage mechanisms 142, the Mth storage mechanisms 144, or combination thereof, can include low latency storage access mechanisms or protocols such as NVMe™. For example, the first storage mechanisms 142, the Mth storage mechanisms 144, or combination thereof, can include a Direct Memory Access (DMA) mechanism 146 for parallel exchanges, communication, transfers, scalability, high performance, or combination thereof, with the servers 106.

In an embodiment, the communication block 104 can include communication devices 152 including a network, physical interconnect, communication devices, network devices, a switching network, switch fabric, a Clos network, Clos fabric, interconnect, or combination thereof. The communication block 104 can further support communication mechanisms 154 such as network mechanisms or protocols including non-volatile memory express (NVMe™), Peripheral Component Interconnect Express, also known as PCI Express, PCI-Express, PCI-E, or PCIe®, Ethernet, Ethernet enhancements, Remote Direct Memory Access, Transmission Control, User Data Protocol hardware acceleration, or combination thereof. For example, communication block 104 with the servers 106 including the management server 112 and the management mechanisms 122 can provide non transparent PCI-e bridging for the servers 106 and the storage devices 108 for supporting, providing, implementing, or combination thereof, a communication transaction 156 such as a storage transaction, storage access, or combination thereof.

It has been discovered that the electronic system 100 with the communication block 104, the servers 106 including the management server 112, the storage devices 108, or combination thereof, provides very high performance and low latency at a low total cost of ownership. The management server 112 can centrally manage and assign the storage devices 108 or a portion of a storage device 108 to any combination of the servers 106 for redundancy, failover, fault replacement, or combination thereof, with low cost and low latency interconnect technology.

It has been discovered that the electronic system 100 with the communication block 104, the servers 106 including the management server 112, the storage devices 108, or combination thereof, provides excellent performance characteristics. The management mechanisms 122, the communication mechanisms 154, the first storage mechanisms 142 of the first device 132, the Mth storage mechanisms 144 of the Mth storage device 134, or combination thereof, can provide a Direct Memory Access (DMA) mechanism 146 for very high performance.

It has been discovered that the electronic system 100 with the communication block 104, the servers 106 including the management server 112, the storage devices 108, or combination thereof, provides scalability. The communication block 104, the servers 106, the storage devices 108, or combination thereof, can include domain isolation bridging technology for accessing shared storage devices 108 with the servers 106.

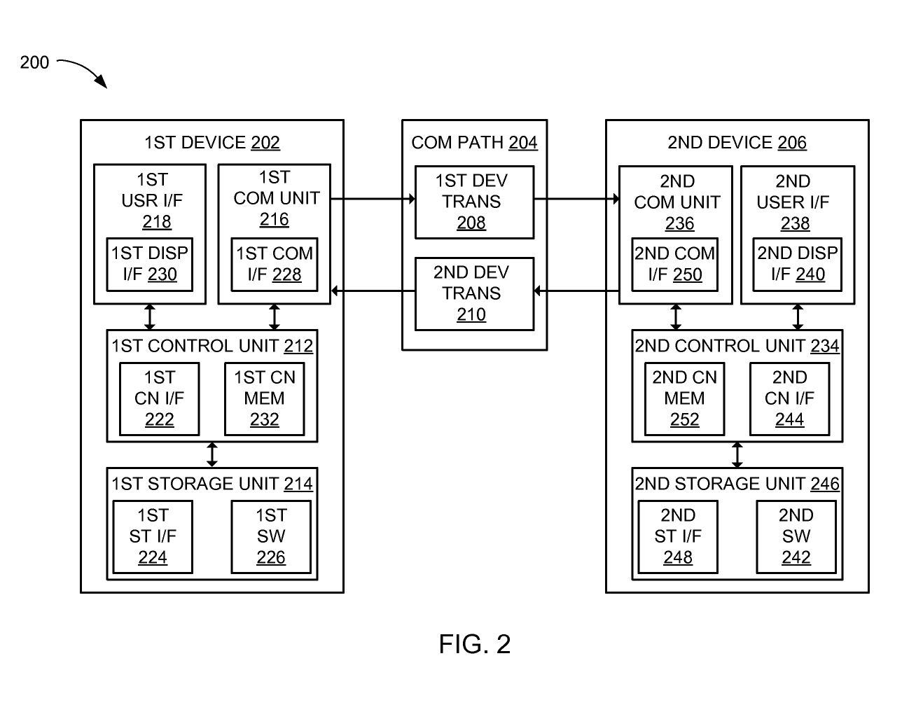

Referring now to FIG. 2, therein is shown an example of a block diagram of an electronic system 200 in an embodiment of the invention. The electronic system 200 can include a first device 202, a communication path 204, and a second device 206. The servers 106 of FIG. 1, the storage devices 108 of FIG. 1, or combination thereof, can include the first device 202, the second device 206, or combination thereof. The communication block 104 of FIG. 1 can include the communication path 204. The electronic system 100 of FIG. 1 can be implemented with the electronic system 200, can include the electronic system 200, or combination thereof.

The first device 202 can send information in a first device transmission 208 over the communication path 204 to the second device 206. The second device 206 can send information in a second device transmission 210 over the communication path 204 to the first device 202.

For illustrative purposes, the electronic system 100 is shown with the first device 202 as a client device, although it is understood that the electronic system 100 can have the first device 202 as a different type of device. For example, the first device 202 can be a server.

Also for illustrative purposes, the electronic system 200 is shown with the second device 206 as a server, although it is understood that the electronic system 200 can have the second device 206 as a different type of device. For example, the second device 206 can be a client device, a storage device, or combination thereof.

For brevity of description in this embodiment of the present invention, the first device 202 will be described as a server device and the second device 206 will be described as a client or storage device. The embodiment of the present invention is not limited to this selection for the type of devices. The selection is an example of an embodiment of the present invention.

The first device 202 can include a first control unit 212, a first storage unit 214, a first communication unit 216, and a first user interface 218. The first control unit 212 can include a first control interface 222. The first control unit 212 can execute a first software 226 to provide functions or operations of the electronic system 100.

The first control unit 212 can be implemented in a number of different manners. For example, the first control unit 212 can be a processor, an application specific integrated circuit (ASIC), an embedded processor, a microprocessor, a hardware control logic, a hardware finite state machine (FSM), a digital signal processor (DSP), field programmable gate array (FPGA), or a combination thereof. The first control interface 222 can be used for communication between the first control unit 212 and other functional units in the first device 202. The first control interface 222 can also be used for communication that is external to the first device 202.

The first control interface 222 can receive information from the other functional units or from external sources, or can transmit information to the other functional units or to external destinations. The external sources and the external destinations refer to sources and destinations external to the first device 202 including through the communication path 204.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226 including machine code, firmware, embedded code, application software, a function, a call to a function, a code block, or a combination thereof. The first storage unit 214 can also store the relevant information including data such as images, information, programs, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM), dynamic random access memory (DRAM), or combination thereof.

The first storage unit 214 can include a first storage interface 224. The first storage interface 224 can be used for communication between and other functional units in the first device 202. The first storage interface 224 can also be used for communication that is external to the first device 202.

The first storage interface 224 can receive information from the other functional units or from external sources, or can transmit information to the other functional units or to external destinations. The external sources and the external destinations refer to sources and destinations external to the first device 202.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 202. For example, the first communication unit 216 can permit the first device 202 to communicate with the second device 206, an attachment, such as a peripheral device or a computer desktop, and the communication path 204.

The first communication unit 216 can also function as a communication hub allowing the first device 202 to function as part of the communication path 204 and not limited to an end point or terminal unit to the communication path 204. The first communication unit 216 can include active and passive components, such as microelectronics or an antenna, for interaction with the communication path 204.

The first communication unit 216 can include a first communication interface 228. The first communication interface 228 can be used for communication between the first communication unit 216 and other functional units in the first device 202. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 can allow a program, an internal operating system module, a device driver, a user (not shown), or combination thereof, to interface and interact with the first device 202. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can optionally include a display, a projector, a video screen, a speaker, or any combination thereof. The first display interface 230 can display information stored in a first control memory 232 of the first control unit 212. The first control memory 232 can include a memory device including a volatile memory device such as static random access memory (SRAM), dynamic random access memory (DRAM), other memory technology device, or combination thereof.

The first control unit 212 can optionally operate the first user interface 218 to display information generated by the electronic system 200. The first control unit 212 can also execute the first software 226 for the other functions of the electronic system 100, storage in the first control memory 232, or combination thereof. The first control unit 212 can further execute the first software 226 for interaction with the communication path 204 via the first communication unit 216.

The second device 206 can be optimized for implementing an embodiment of the present invention in a multiple device embodiment with the first device 202. The second device 206 can provide the additional or higher performance processing power compared to the first device 202, additional functions, additional operations, additional storage, additional performance, or combination thereof. The second device 206 can include a second control unit 234, a second communication unit 236, and a second user interface 238.

The second user interface 238 can allow a program, an internal operating system module, a device driver, a user (not shown), or combination thereof, to interface and interact with the second device 206. The second user interface 238 can include an input device and an output device. Examples of the input device of the second user interface 238 can include a program running on servers operating on big data processing tasks, a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide functions or operations of the second device 206 of the electronic system 200. The second software 242 can operate in conjunction with the first software 226. The second control unit 234 can provide additional functions, additional operations, additional storage, additional performance, or combination thereof, compared to the first control unit 212.

The second control unit 234 can optionally operate the second user interface 238 to display information. The second control unit 234 can also execute the second software 242 for the other functions of the electronic system 200, including operating the second communication unit 236 to communicate with the first device 202 over the communication path 204.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 206. The second controller interface 244 can also be used for communication that is external to the second device 206.

The second controller interface 244 can receive information from the other functional units or from external sources, or can transmit information to the other functional units or to external destinations. The external sources and the external destinations refer to sources and destinations external to the second device 206 including through the communication path 204.

The second controller interface 244 can be implemented in different ways and can include different implementations depending on which functional units or external units are being interfaced with the second controller interface 244. For example, the second controller interface 244 can be implemented with a software program, hardware logic, firmware, or a combination thereof.

A second storage unit 246 can store the second software 242 including machine code, firmware, embedded code, application software, a function, a call to a function, a code block, or a combination thereof. The second storage unit 246 can also store the relevant information including data such as incoming data, previously presented data, image data, sound data, any data, any data, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the electronic system 100 is shown with the second storage unit 246 as a single hierarchy storage system, although it is understood that the electronic system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second device 206. The second storage interface 248 can also be used for communication that is external to the second device 206.

The second storage interface 248 can receive information from the other functional units or from external sources, or can transmit information to the other functional units or to external destinations. The external sources and the external destinations refer to sources and destinations external to the second device 206.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 206. For example, the second communication unit 236 can permit the second device 206 to communicate with the first device 202 over the communication path 204.

The second communication unit 236 can also function as a communication hub allowing the second device 206 to function as part of the communication path 204 and not limited to be an end point or terminal unit to the communication path 204. The second communication unit 236 can include active and passive components, such as microelectronics or an antenna, for interaction with the communication path 204.

The second communication unit 236 can include a second communication interface 250. The second communication interface 250 can be used for communication between the second communication unit 236 and other functional units in the second device 206. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 204 to send information to the second device 206 in the first device transmission 208. The second device 206 can receive information in the second communication unit 236 from the first device transmission 208 of the communication path 204.

The second communication unit 236 can couple with the communication path 204 to send information to the first device 202 in the second device transmission 210. The first device 202 can receive information in the first communication unit 216 from the second device transmission 210 of the communication path 204. The electronic system 100 can be executed by the first control unit 212, the second control unit 234, or a combination thereof.

For illustrative purposes, the second device 206 is shown with the partition having the second user interface 238, the second storage unit 246, the second control unit 234, and the second communication unit 236, although it is understood that the second device 206 can have a different partition. For example, the second software 242 can be partitioned differently such that some or all of its function can be in the second control unit 234 and the second communication unit 236. Also, the second device 206 can include other functional units not shown in FIG. 2 for clarity.

In manner similar to the first control unit 212, the second control unit 234 can include a second control memory 252 with a memory device including a volatile memory device such as static random access memory (SRAM), dynamic random access memory (DRAM), other memory technology device, or combination thereof. Functions of the electronic system 100 can store information in the second control memory 252 for use by other functional units.

The functional units in the first device 202 can work individually and independently of the other functional units. The first device 202 can work individually and independently from the second device 206 and the communication path 204.

The functional units in the second device 206 can work individually and independently of the other functional units. The second device 206 can work individually and independently from the first device 202 and the communication path 204.

For illustrative purposes, the electronic system 200 is described by operation of the first device 202 and the second device 206. It is understood that the first device 202 and the second device 206 can operate any of the modules and functions of the electronic system 100.

The modules described in this application can be implemented as instructions stored on a non-transitory computer readable medium to be executed by a first control unit 212, the second control unit 234, or a combination thereof. The non-transitory computer medium can include the first storage unit 214, the second storage unit 246, or a combination thereof. The non-transitory computer readable medium can include non-volatile memory, such as a hard disk drive (HDD), non-volatile random access memory (NVRAM), solid-state storage device (SSD), or combination thereof. The non-transitory computer readable medium can be integrated as a part of the electronic system 200 or installed as a removable portion of the electronic system 200.

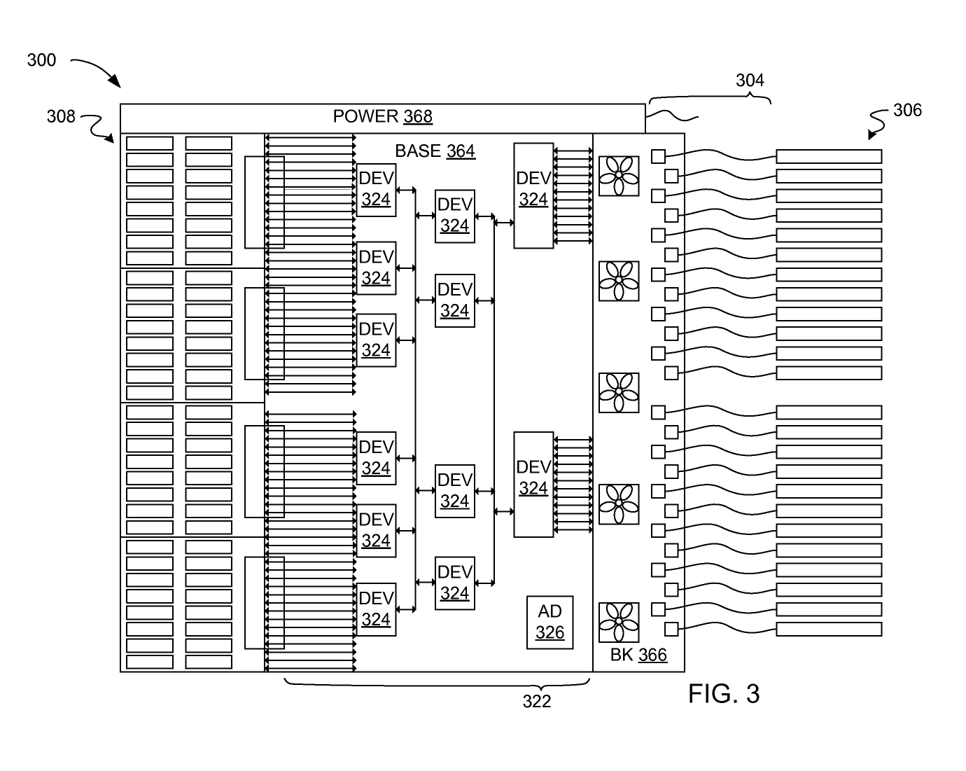

Referring now to FIG. 3, therein is shown an example of a plan view of a portion of an electronic system 300 in an embodiment of the invention. The electronic system 300 can include a communication structure 304, servers 306, storage devices 308, or combination thereof in a manner similar to the electronic system 100 of FIG. 1, the electronic system 200 of FIG. 2, or combination thereof. In an embodiment, the electronic system 300 with storage control mechanism can provide connection, communication, or combination thereof for storage devices and servers.

In an embodiment, the electronic system 300 can include switch fabric, server management, unified address space, or combination thereof, for providing a scalable, multi-server, multi-storage system with very high performance, low latency, and low total cost of ownership (TCO). The electronic system 300 including low cost interconnect technology such as switch fabric with simplified addressing such as unified addresses for connecting multiple servers 306 with multiple storage devices 308.

For example, the communication structure 304 can include the communication path 204 of FIG. 2, be implemented as the communication path 204, or combination thereof. The servers 306, the storage devices 308, or combination thereof, can include the first device 202 of FIG. 2, the second device 206 of FIG. 2, or combination thereof. The servers 306, the storage devices 308, or combination thereof, can also be implemented as the first device 202, the second device 206, or combination thereof. The electronic system 300 can include the electronic system 100, the electronic system 200, or combination thereof. The electronic system 300 can also be implemented as the electronic system 100, the electronic system 200, or combination thereof.

In an embodiment, the electronic system 300 can include switch fabric, server management, unified address space, or combination thereof, for providing a scalable, multi-server, multi-storage system with very high performance, low latency, and low total cost of ownership (TCO). The electronic system 300 including low cost interconnect technology such as switch fabric with simplified addressing such as a unified or flat address space or range for connecting multiple of the servers 306 with multiple of the storage devices 308.

In an embodiment, the communication structure 304 can include physical interconnect, communication devices, network devices, switch devices, switch fabric devices, or combination thereof. The communication structure 304 can include high performance, low latency interconnect fabric for point to point, parallel connectivity for the servers 306 and the storage devices 308. The communication structure 304 can provide any of the servers 306 exchanges with any number of combinations of the storage devices 308.

In an embodiment, the servers 306 can include computer devices, compute servers, storage servers, a rack of servers, a server array, server blades, any servers, or combination thereof. The servers 306 can include a management server such as the management server 112 of FIG. 1. For illustrative purposes, twenty-four (24) of the servers 306 are shown although it is understood that any number of the servers 306 may be included. For example, two or more of the servers 306 can share at least one of the storage devices 308.

In an embodiment, the storage devices 308 can include storage devices, storage drives, solid state storage drives, hard disk drives, any electronic storage, or combination thereof. For illustrative purposes, sixty-four (64) of the storage devices 308 are shown although it is understood that any number of the storage devices 308 may be included.

For example, any number of the storage devices 308 can include Direct Memory Access (DMA) 146 for parallel exchanges, communication, transfers, scalability, high performance, or combination thereof, with the servers 306. End point devices such as the storage devices 308 can fetch and process commands or transactions directly from communication or handshake of host end point devices such as the servers, 306, server application virtual memory with non-volatile memory express (NVMe™), any similar technology, or combination thereof.

In an embodiment, a communication structure 304 can include physical interconnect, cables, connectors, or combination thereof. For example, the communication structure 304 can provide communication of or transport for Peripheral Component Interconnect Express, also known as PCI Express, PCI-Express, PCI-E, or PCIe®. Further for example, communication structure 304 can provide non transparent PCI-e bridging.

In an embodiment, the electronic system 300 can include transaction mechanisms 322 in a manner similar to the management mechanisms 122 of FIG. 1, the storage mechanisms 142 of FIG. 1, the communication mechanisms 154 of FIG. 1, or combination thereof. The transaction mechanisms 322 can include connection devices 324 including interconnect, network devices, communication devices, switches, switch fabric, PCIe® switches, or combination thereof.

For example, the transaction mechanisms 322 can provide a flat shared address domain, domain isolation bridging, or combination thereof. A non-transparent bridge with flat shared address domain, domain isolation bridging can provide high performance, low latency interconnect for point to point, parallel connectivity for multiple of the servers 304 with any number or combination of the storage devices 308.

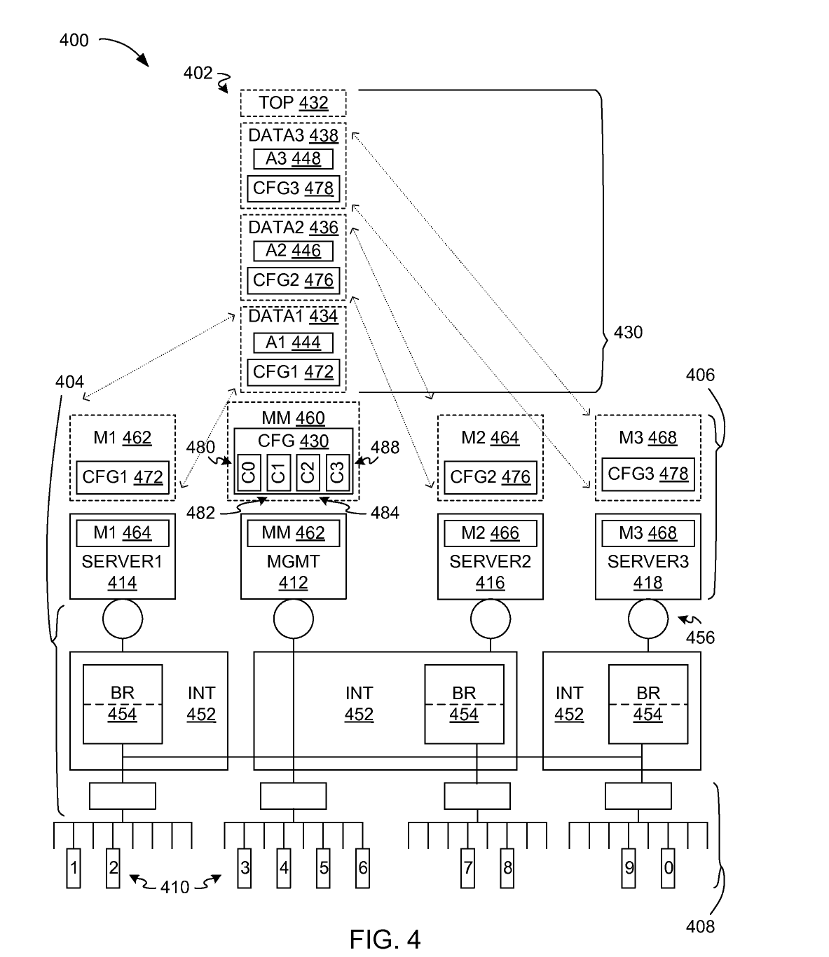

In an embodiment the communication structure 304 can connect the servers 306 and the storage devices 308 in a manner similar to the communication block 204, the servers 206, the storage devices 208, any number of components of the electronic system 200, or combination thereof. For example, the electronic system 300 with the transaction mechanism 322 and address translation can connect the servers 306 and the storage devices 308. The transaction mechanism 322 including address translation does not require a non-volatile memory controller such as an ethernet switch with a non-volatile memory controller. An address mechanism 326 can include address translation, unified address space, a unified address range, translated address map, simplified addressing, flat addressing, a unified flat address space, programmable address translation, or combination thereof. Further description regarding address mechanisms, such as the address mechanism 326, is at least provided in the description of FIG. 4.

The electronic system 300 can include a base 364 including a base board, a back 366 including a back plane, power 368 including a power supply, communication devices, network devices, switch devices, switch fabric devices, or combination thereof or combination thereof. The base 364 can provide physical structure for components of the electronic system 300 and can optionally include or integrate the back 366, the power 368, or combination thereof. The back 366 can include interconnect components, connection components, ports, terminals, cooling vents, fans, or combination thereof. The power 368 can include a power supply, power connection components, power receptacles, or combination thereof.

For example, the communication structure 364 can provide Peripheral Component Interconnect Express (also known as PCI Express, PCI-Express, PCI-E, or PCIe®) connectivity. Further for example, communication structure 364 can provide non transparent PCI-e bridging.

It has been discovered that the electronic system 300 with the servers 306 including the management server, the communication structure 304, the storage devices 308, or combination thereof, provides address translation for storage transactions without the need for a specialized controller. The electronic system 300 can connect the servers 306 and the storage devices 308 with the transaction mechanism 322 including address translation without the need for a non-volatile memory controller.

It has been discovered that the electronic system 300 with the servers 306 including the management server, the communication structure 304, the storage devices 308, or combination thereof, provides a scalable, multi-server, multi-storage system. The electronic system 300 includes low cost interconnect technology such as switch fabric with simplified addressing such as unified addresses for connecting multiple of the servers 306 with multiple of the storage devices 308.

It has been discovered that the electronic system 300 with the servers 306 including the management server, the communication structure 304, the storage devices 308, or combination thereof, provides scalability. The transaction mechanism 322, the address mechanism 326, or combination thereof, can provide a flat shared address domain, domain isolation bridging, or combination thereof, for multiple of the servers 304 accessing multiple of the storage devices 108.

Referring now to FIG. 4, therein is shown an example of a plan view of a portion of an electronic system 400 in an embodiment of the invention. The electronic system 400 can include an address structure 402 such as a unified address space to provide storage control and can include or be implemented as the address mechanism 326 of FIG. 3, the transaction mechanism 322 of FIG. 3, the management mechanisms 122 of FIG. 1, the storage mechanisms 142 of FIG. 1, the communication mechanisms 154 of FIG. 1, or combination thereof.

For example, in a manner similar to the address mechanism 326, the address structure 402 can provide address translation, a unified address space, a unified address range, a translated address map, simplified addressing, flat addressing, a unified flat address space, programmable address translation, a flat shared address domain, domain isolation bridging, or combination thereof. The address structure 402 can provide access for servers and storage devices. Multiple of the servers 106 of FIG. 1, servers 306 of FIG. 3, the first device 202, the second device 206, or combination thereof, can access multiple of the storage devices 108, the storage devices 308, the first device 202, the second device 206, or combination thereof.

In an embodiment, the electronic system 400 can include switch fabric, server management, unified address space, unified address range, or combination thereof, for providing a scalable, multi-server, multi-storage system with very high performance, low latency, and low total cost of ownership (TCO). The electronic system 400 including low cost interconnect technology such as switch fabric with simplified addressing such as unified addresses for connecting multiple servers 406 with multiple storage devices 408 including multiple drives 410.

For illustrative purposes, four (4) of the servers 406 are shown although it is understood that any number of type of the server 406 may be included. Further for illustrative purposes, four (4) of the storage devices 408 with ten (10) of the drives 410 are shown although it is understood that any number or type of the storage devices 408 or the drives 410 may be included.

Embodiments of the electronic system 100 of FIG. 1, the electronic system 200 of FIG. 2, the electronic system 300 of FIG. 3, or combination thereof, can include the address structure 402 and communication structure 404. The address structure 402 can provide addressing such as unified addressing, flat addressing, a unified flat address space, a unified address range, programmable address translation, or combination thereof, for connecting multiple servers 406 with multiple storage devices 408.

For example, the servers 406 can include the servers 106 of FIG. 1, the first device 202 of FIG. 2, the second device 206 of FIG. 2, the servers 306 of FIG. 3, or combination thereof. The storage devices 408 can include the storage devices 108 of FIG. 1, the first device 202 of FIG. 2, the second device 206 of FIG. 2, the storage devices 308 of FIG. 3, or combination thereof.

In an embodiment, the servers can also include a management server 412 such as a management host in a manner similar to the management server 112 of FIG. 1. The management server 412 can assign and directly address resources of servers, storage devices, or combination thereof, including system resources such as system memory, storage configuration registers, storage drive configuration, system peripherals, system storage devices, any memory, or combination thereof, with a unified address space. The management server 412 can provide computing such as general purpose computing in a manner similar to other servers such as the servers 406.

For example, a unified address space 402, which can include a unified address range, can include the management server 412 providing non-translated addressing to access the system resources. The unified address space 402 can also include non-management servers including a first sever 414, a second server 416, a third server 418, or combination thereof, using non-transparent bridge address translation to the access the system resources.

Further for example, the unified address space 402 can assign each of the storage devices 408, in part or in entirety, to one or more of the servers. The storage devices 408 can include solid state storage devices (SSD), hard disk drive (HDD), non-volatile random access memory (NVRAM), any non-volatile memory devices, any electronic storage device, or combination thereof. The unified address space 402 can also include a high performance storage access protocol or mechanism such as non-volatile memory express (NVMe™).

In an embodiment, the address structure 402 such as the unified address space can include data configuration block 430, which can be stored on the servers 406, the storage devices 408, or combination thereof. The data configuration block 430 can include data fields for shared access to storage devices 408. The data fields can include a memory top 432, a first data field 434, a second data field 436, a third data field 438, or combination thereof. For example, the first data field 434, the second data field 436, the third data field 438, or combination thereof, can include storage addresses for the servers 406. Addresses can be enumerated based on the offset for each of the first data field 434, the second data field 436, the third data field 438, and the memory top 432.

For example, a manage block 460 such as a memory or storage block of the management server 412, can store addresses, the first data field 434, the second data field 436, the third data field 438, the memory top 432, or combination thereof. The stored addresses of the manage block 460 can be used by the management server 412 to assign shared access to the storage devices 408 or a portion of a storage device 408 with the communication structure 404. Similarly, the first server 414 can include a first memory block 462, the second server 416 can include a second memory block 464, the third server 418 can include a third memory block 468, or combination thereof.

In an embodiment, the communication structure 404 can include physical interconnect, communication devices, network devices, switch devices, switch fabric devices, or combination thereof. The communication structure 404 can include one or more interconnect 452, one or more bridge 454 such as an NT bridge, one or more server communication device 456, or combination thereof. For illustrative purposes, three (3) interconnects 452 and three (3) bridges 454 are shown although it is understood that any number of the interconnects 452 and any number of the bridges 454 may be included.

In an embodiment, the interconnect 452 can include a switch, switch fabric, any network device, any interconnect device, or combination thereof. The bridge 454 can provide one or more of a transparent bridge, a non-transparent (NT) bridge, a non-transparent virtual (NTV) bridge, a non-transparent link (NTL) bridge, any suitable bridge, any suitable interconnect technology, domain isolation bridging, Ethernet, Ethernet accelerated versions, Remote Direct Memory Access, or combination thereof. For example the communication structure 404 can provide five hundred twelve bytes (512 Bytes) of data between the servers 406 and the storage devices 408.

In an embodiment, the first data field 434 of the data configuration block 430 can provide first addresses 444, such as an address range, for a first configuration block 472 of the first memory block 462. The first configuration block 472 can include a translated or offset range corresponding to configuration information for one or more of the drives 410. The first configuration block 472 can provide access for the first server 414 to the storage devices 408. For example, the first addresses 444 can provide address translation copied from the data configuration block 430 to the first configuration block 472, for enabling the first server 414 to access one or more of the drives 410 of the storage device 408.

In an embodiment, the second data field 436 of the data configuration block 430 can provide second addresses 446, such as an address range, for a second configuration block 476 of the second memory block 464. The second configuration block 476 can include a translated or offset range corresponding to configuration information for one or more of the drives 410. The second configuration block 476 can provide access for the second server 416 to the storage devices 408. For example, the second addresses 446 can provide address translation copied from the data configuration block 430 to the second configuration block 476, for enabling the second server 416 to access one or more of the drives 410 of the storage device 408.

In an embodiment, the third data field 438 of the data configuration block 430 can provide third addresses 448, such as an address range, for a third configuration block 478 of the third memory block 468. The third configuration block 478 can provide access for the third server 418 to the storage devices 408. For example, the third addresses 448 can provide address translation copied from the data configuration block 430 to the third configuration block 478, for enabling the third server 418 to access one or more of the drives 410 of the storage device 408. The data configuration block 430 can include base configuration data 480, first configuration data 482, second configuration data 484, third configuration data 488, or combination thereof, which can include the address translation described above.

It has been discovered that the electronic system 400 with the management server 412, the communication structure 404, or combination thereof, can provide a cost efficient, scalable, multi-server, multi-storage system with low total cost of ownership (TCO). The management server 412, the communication structure 404, or combination thereof, can include low cost interconnect technology with simplified addressing for connecting multiple servers 406 with multiple storage devices 408 including multiple drives 410.

It has been discovered that the electronic system 400 with the manage block 460, the data configuration block 430, the first data field 434, the second data field 436, the third data field 438, a unified address range, or combination thereof, can provide a scalable, multi-server, multi-storage system with very high performance and low latency. The data configuration block 430 such as a unified address space, the manage block 460, or combination thereof, can provide addressing for the first server 414, the second server 416, the third server 418, the management server 412, or combination thereof, to access the storage devices 408.

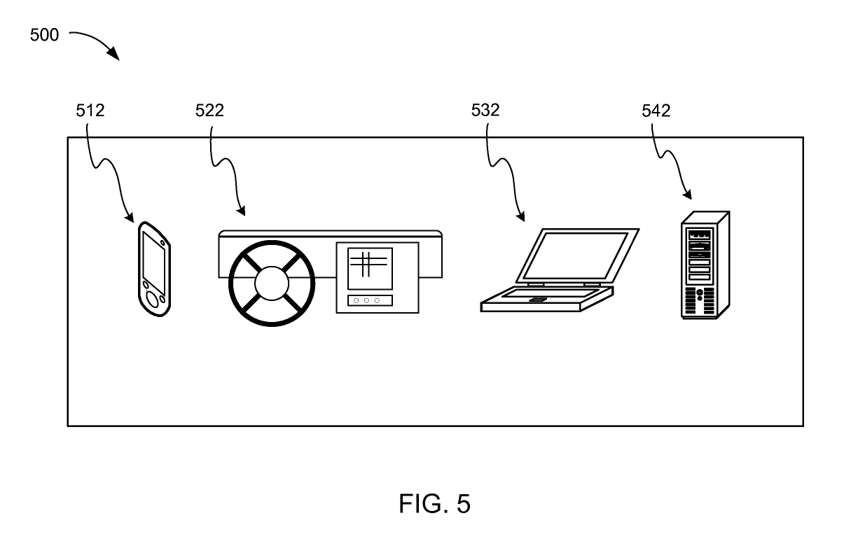

Referring now to FIG. 5, therein is shown examples embodiments 500 of the invention. The example embodiments 500 include application examples for the electronic system 100 of FIG. 1, the electronic system 200 of FIG. 2, the electronic system 300 of FIG. 3, or combination thereof. The example embodiments 500 can include a smart phone 512, a dash board of an automobile 522, a notebook computer 532, a server 542 such as data center servers, storage servers, storage racks, or combination thereof.

In embodiments, these application examples illustrate purposes or functions of various embodiments of the invention and importance of improvements in performance, latency, scalability, and cost effectiveness, including improved bandwidth, total cost of ownership, or combination thereof. For example, the transaction mechanisms 322 of FIG. 3, management mechanisms 122 of FIG. 1 storage mechanisms 142 of FIG. 1 the communication mechanisms 154 of FIG. 1 or combination thereof, can maximize system performance, minimize memory transaction latency, minimize area of the memory devices, minimize area of the interconnect, minimize cost of interconnect, minimize interconnect bandwidth consumption, minimize memory bandwidth consumption, optimize cost effectiveness, or combination thereof.

In an example where an embodiment of the invention is integrated physical logic circuits integrated in the control unit 112 of FIG. 1, the storage unit 114 of FIG. 1, or combination thereof, storage transactions can be significantly faster than other devices without the transaction mechanisms 322, management mechanisms 122, storage mechanisms 142, the communication mechanisms 154, or combination thereof. Various embodiments of the invention provide very high performance transactions with low latency thereby improving system performance, improving energy efficiency, enabling new memory technologies, enabling compatibility with current memory hierarchies, providing transparent implementation for user applications, or combination thereof.

The electronic system 100, such as the smart phone 512, the dash board of the automobile 522, the notebook computer 532, and the server 542, can include a one or more of a subsystem (not shown), such as a printed circuit board having various embodiments of the invention, or an electronic assembly (not shown) having various embodiments of the invention. The electronic system 100 can also be implemented as an adapter card in the smart phone 512, the dash board of the automobile 522, the notebook computer 532, and the server 542.

Thus, the smart phone 512, the dash board of the automobile 522, the notebook computer 532, the server 542, other electronic devices, or combination thereof, can provide significantly faster throughput with the electronic system 100 such as processing, output, transmission, storage, communication, display, other electronic functions, or combination thereof. For illustrative purposes, the smart phone 512, the dash board of the automobile 522, the notebook computer 532, the server 542, other electronic devices, or combination thereof, are shown although it is understood that the electronic system 100 can be used in any electronic device.

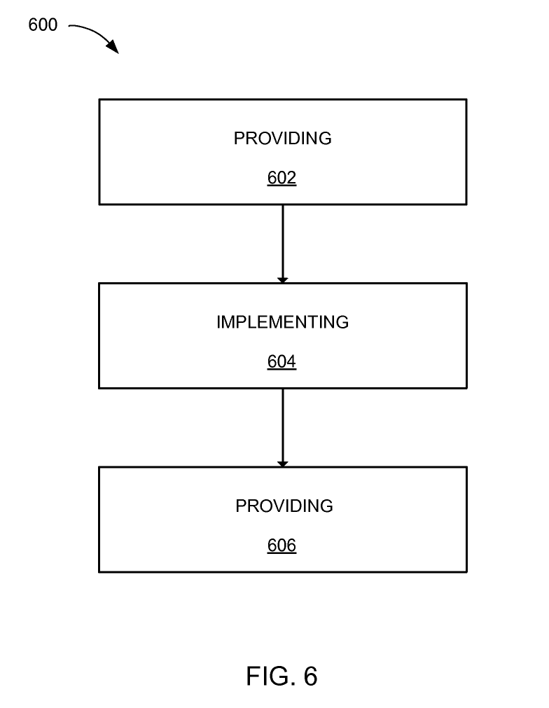

Referring now to FIG. 6, therein is shown a flow chart of a method 600 of operation of the electronic system 100 in an embodiment of the present invention. The method 600 includes: providing, with a management server, a management mechanism with an address structure having a unified address space in a block 602; implementing, with a communication block coupled to the management server, a communication transaction based on the management mechanism with the address structure having the unified address space in a block 604; and providing, with a server coupled to the communication block, the communication transaction with a storage device based on the management mechanism with the address structure having the unified address space in a block 606.

In an embodiment, the method 600 for the block 604 can include connecting the management server with a data configuration block. The method 600 for the block 604 can include assigning one of the storage devices to the server. The method 600 for the block 604 can include assigning a portion of one of the storage devices to the server.

In an embodiment, the method 600 for the block 606 can include accessing the storage devices with multiple drives. The method 600 for the block 606 can include accessing the storage devices with a direct memory access mechanism. The method 600 for the block 606 can include accessing a solid state drive. The method 600 can further include providing a second server, coupled to the management server; and accessing a second storage device assigned to the second server.

In an embodiment, the method 600 for the block 608 can include implementing the communication block with a connection device. The method 600 for the block 608 can include implementing the communication block supporting a communication mechanism for a network protocol. The method 600 can further include providing a second server, coupled to the management server; and accessing a second storage device assigned to the second server.

In an embodiment, the electronic system 100 of FIG. 1 with the communication block 104 of FIG. 1, the servers 106 of FIG. 1 including the management server 112 of FIG. 1, the storage devices 108 of FIG. 1, or combination thereof, provides very high performance and low latency at a low total cost of ownership. The management server 112 can centrally manage and assign the storage devices 108 or a portion of a storage device 108 to any combination of the servers 106 for redundancy, failover, fault replacement, or combination thereof, with low cost and low latency interconnect technology.

In an embodiment, the electronic system 100 with the communication block 104 of FIG. 1, the servers 106 including the management server 112, the storage devices 108, or combination thereof, provides excellent performance characteristics. The management mechanisms 122 of FIG. 1, the communication mechanisms 154 of FIG. 1, the first storage mechanisms 142 of FIG. 1 of the first device 132 of FIG. 1, the Mth storage mechanisms of the Mth storage device 134 of FIG. 1, or combination thereof, can provide Direct Memory Access (DMA) 146 for very high performance including use of low utilization servers.

In an embodiment, the electronic system 100 with the communication block 104, the servers 106 including the management server 112, the storage devices 108, or combination thereof, provides scalability. The communication block 104, the servers 106, the storage devices 108, or combination thereof, can include domain isolation bridging technology for accessing shared storage devices 108 with the servers 106.

In an embodiment, the electronic system 300 of FIG. 3 with the servers 306 of FIG. 3 including the management server, the communication structure 304 of FIG. 3, the storage devices 308 of FIG. 3, or combination thereof, provides address translation for storage transactions without the need for a specialized controller. The electronic system 300 can connect the servers 306 and the storage devices 308 with the transaction mechanism 322 of FIG. 3 including address translation without the need for a non-volatile memory controller.

In an embodiment, the electronic system 300 with the servers 306 including the management server, the communication structure 304, the storage devices 308, or combination thereof, provides a scalable, multi-server, multi-storage system. The electronic system 300 includes low cost interconnect technology such as switch fabric with simplified addressing such as unified addresses for connecting multiple of the servers 306 with multiple of the storage devices 308.

In an embodiment, the electronic system 300 with the servers 306 including the management server, the communication structure 304, the storage devices 308, or combination thereof, provides scalability. The transaction mechanism 322 such as a switching fabric mechanism, the connection devices 324 of FIG. 3, the address mechanism 326 of FIG. 3, or combination thereof, can provide a flat shared address domain, domain isolation bridging, or combination thereof, for multiple of the servers 304 accessing multiple of the storage devices 108.

In an embodiment, the electronic system 400 of FIG. 4 with the management server 412 of FIG. 4, the communication structure 404 of FIG. 4, or combination thereof, can provide a cost efficient, scalable, multi-server, multi-storage system with low total cost of ownership (TCO). The management server 412, the communication structure 404, or combination thereof, can include low cost interconnect technology with simplified addressing for connecting multiple servers 406 of FIG. 4 with multiple storage devices 408 of FIG. 4 including multiple drives 410 of FIG. 4.

In an embodiment, the electronic system 400 of FIG. 4 with the mange block 460 of FIG. 4, the data configuration block 430 of FIG. 4, the first data field 434 of FIG. 4 such as an address range, the second data field 436 of FIG. 4 such as an address range, the third data field 438 of FIG. 4 such as an address range, a unified address range, or combination thereof, can provide a scalable, multi-server, multi-storage system with very high performance and low latency. The data configuration block 430, such as an SSD configuration address range, can provide addressing and information for the first server 414 of FIG. 4, the second server 416 of FIG. 4, the third server 418 of FIG. 4, or combination thereof, to access the storage devices 408.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a management server providing a management mechanism with an address structure having a unified address space;
a communication block, coupled to the management server, configured to implement a communication transaction based on the management mechanism with the address structure having the unified address space; and
a server, coupled to the communication block, providing the communication transaction with a storage device based on the management mechanism with the address structure having the unified address space.

2. The system as claimed in claim 1 wherein the management server includes a data configuration block.

3. The system as claimed in claim 1 wherein the management server includes assigning one of the storage devices to the server.

4. The system as claimed in claim 1 wherein the management server includes assigning a portion of one of the storage devices to the server.

5. The system as claimed in claim 1 further comprising:
a second server, coupled to the management server; and
a second storage device assigned to the second server.

6. The system as claimed in claim 1 wherein the storage device includes multiple drives.

7. The system as claimed in claim 1 wherein the storage device includes a direct memory access mechanism.

8. The system as claimed in claim 1 wherein the storage device includes a solid state drive.

9. The system as claimed in claim 1 wherein the communication block includes a connection device.

10. The system as claimed in claim 1 wherein the communication block supports a communication mechanism for a network protocol.

11. A method of operation of an electronic system comprising:
providing, with a management server, a management mechanism with an address structure having a unified address space;
implementing, with a communication block coupled to the management server, a communication transaction based on the management mechanism with the address structure having the unified address space; and
providing, with a server coupled to the communication block, the communication transaction with a storage device based on the management mechanism with the address structure having the unified address space.

12. The method as claimed in claim 11 wherein providing, with the management server, the management mechanism includes connecting the management server with a data configuration block.

13. The method as claimed in claim 11 wherein providing, with the management server, the management mechanism includes assigning the storage device to the server.

14. The method as claimed in claim 11 wherein providing, with the management server, the management mechanism includes assigning a portion of the storage device to the server.

15. The method as claimed in claim 11 further comprising:
providing a second server, coupled to the management server; and
accessing a second storage device assigned to the second server.

16. The method as claimed in claim 11 wherein providing, with the server coupled to the communication block, the communication transaction with the storage device includes accessing the storage device with multiple drives.

17. The method as claimed in claim 11 wherein providing, with the server coupled to the communication block, the communication transaction with the storage device includes accessing the storage device with a direct memory access mechanism.

18. The method as claimed in claim 11 wherein providing, with the server coupled to the communication block, the communication transaction with the storage device includes accessing a solid state drive.

19. The method as claimed in claim 11 wherein implementing, with the communication block coupled to the management server, the communication transaction includes implementing the communication block with a connection device.

20. The method as claimed in claim 11 wherein implementing, with the communication block coupled to the management server, the communication transaction includes implementing the communication block supporting a communication mechanism for a network protocol.
